(19) United States
(12) Patent Application Publication
(10) Pub. No.: US 2007/0295105 A1
(43) Pub. Date: Dec. 27, 2007

(54) Warning device for torque measuring hand tool

(76) Inventor: Chih-Ching Hsieh, Taichung City (TW)

Correspondence Address: PHILLIP LIU, 6980, WHITEOAK DR., RICHMOND, BC, V7EAZ9, US

(21) Appl. No.: 11/448,080

(22) Filed: Jun. 7, 2006

(51) Int. Cl. G01L 1/22

(52) U.S. Cl. 73/862

(57) ABSTRACT

A hand tool includes a handle and a function end is connected to one of two ends of the handle. A strain transducer is connected to a side of the handle and electrically connected with a display member on the handle. The display member has a first light and a second light. The first light lights up when a pre-set torque is about to be reached and the second light lights up when the pre-set torque is reached.

### FIELD OF THE INVENTION

The present invention relates to a hand tool with a warning device which tells the user the pre-set torque is about to be reached.

### BACKGROUND OF THE INVENTION

A conventional hand tool for applying torque to workpieces generally includes a handle and a function end which can be a box open end or an open end. The user mounts the function end to the workpiece such as a bolt head and then rotates the handle so that the torque is applied to the workpiece which is tightened or loosened. In order to apply a precise torque o the workpiece, a strain transducer is used and the strain transducer is attached to the handle so that when the torque is output, the strain transducer measure the small deformation of the handle and calculates the value of the torque. A display member is electrically connected to the strain transducer and shows the digits of the value of the torque. However, the user might not check the display member in time so that some display member is cooperated with an audio member which produces specific sound to inform the user that the pre-set torque is reached. Nevertheless, in a noise circumstance, the specific sound might be ignored and the workpiece might be damaged due to overly rotated.

### SUMMARY OF THE INVENTION

The present invention relates to a hand tool that comprises a handle with a function end connected to one of two ends of the handle. A strain transducer is connected to a side of the handle and electrically connected with a display member on the handle. The display member has a screen, a first light and a second light. The first light lights up when a pre-set torque is about to be reached and the second light lights up when the pre-set torque is reached.

The primary object of the present invention is to provide a warning device which is able to inform the user that the pre-set torque is about to be reached so that the user can check the display member to precisely apply the desired torque to the workpiece.

Another object of the present invention is to provide a warning device for a hand tool wherein when the pre-set torque is reached, at least one of the two lights or both of the two lights up to inform the user.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the hand tool with the warning device of the present invention;

FIG. 2-1 shows a plane view the hand tool with the warning device of the present invention;

FIG. 2-2 shows that the warning device includes a screen and two lights;

FIG. 3 shows that the first light lights up when the pre-set torque is to be reached;

FIG. 4 shows that the second light lights up when the pre-set torque is reached;

FIG. 5 shows another embodiment of the hand tool with the warning device of the present invention;

FIG. 6 shows that the first light lights up when the pre-set torque is to be reached, and

FIG. 7 shows that both the first and second lights are flashing when the pre-set torque is reached.

### DETAILED DESCRIPTION OF THE PREFERRED EMBODIMENT

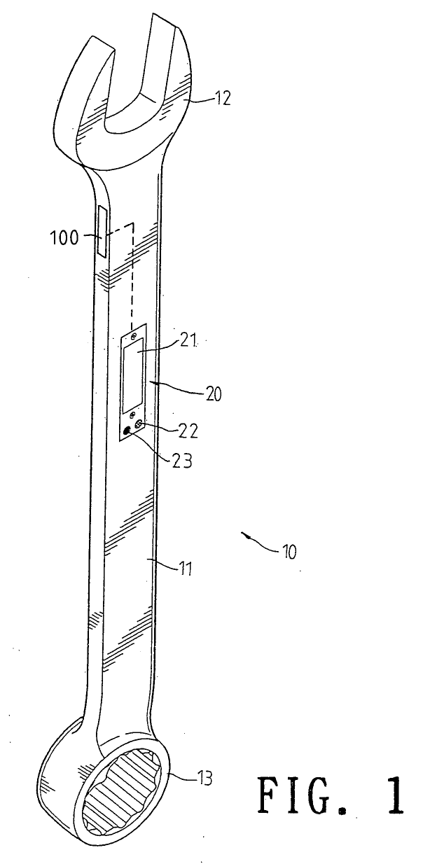

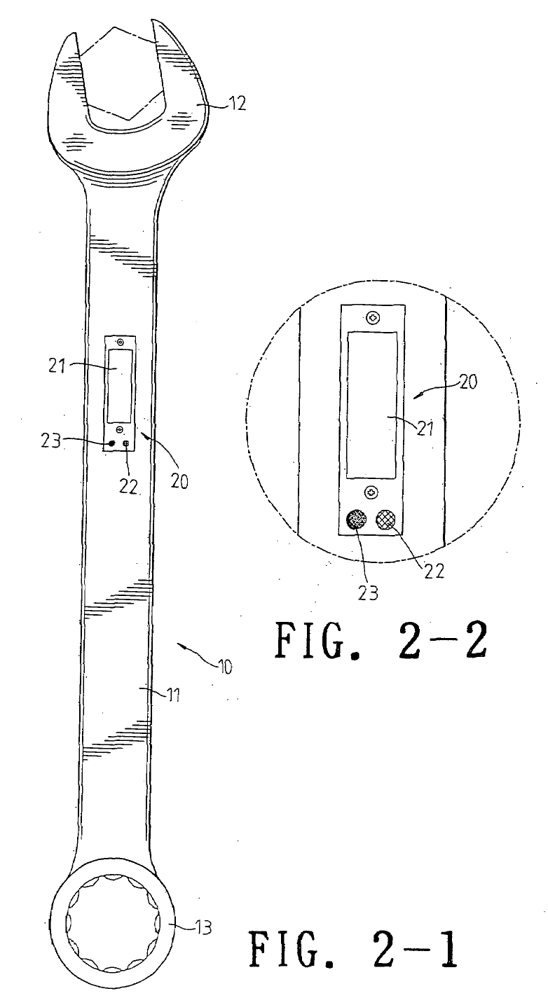

Referring to FIGS. 1, 2-1 and 2-2, the hand tool 10 includes a handle 11 and a first function end 12 and a second function end 13 are respectively connected to two ends of the handle 11. A strain transducer 100 is connected to a side of the handle 11 and electrically connected with a display member 20 on the handle 11. The display member 20 includes a screen 21, a first light 22 which is a green light and a second light 23 which is a red light.

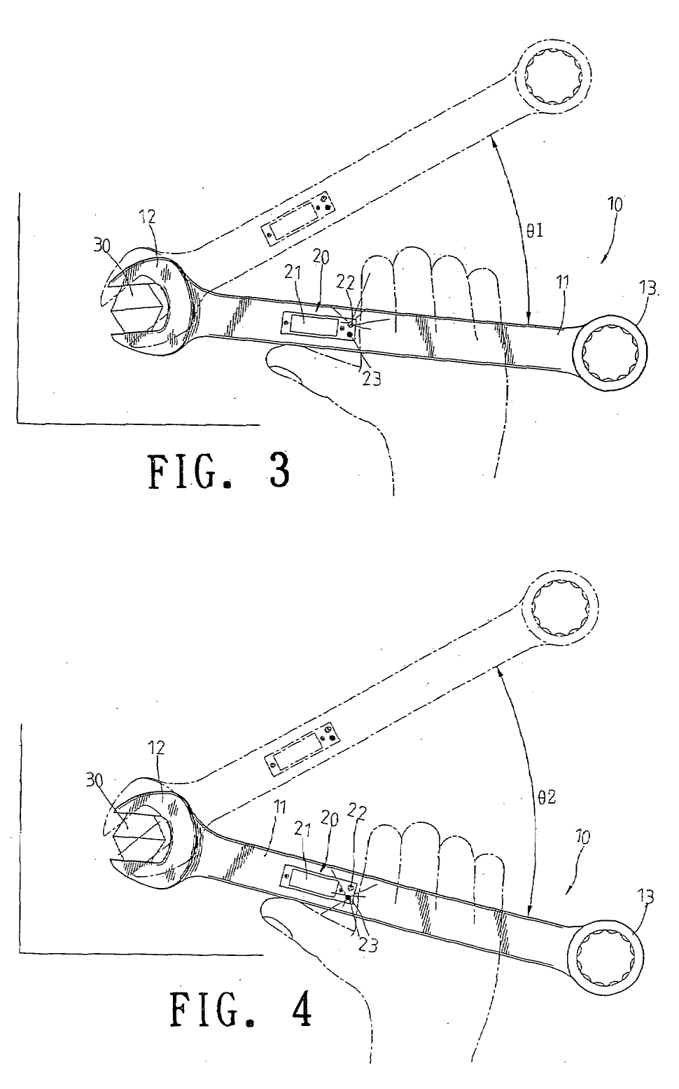

As shown in FIGS. 3 and 4, when using the hand tool 10, the function end 12 is mounted onto a workpiece and the user holds the handle 11 to rotate angle “θ1” to tighten the workpiece. When the pre-set torque is about to be reached, such as 90% of the pre-set torque, the first light 22 lights up so that the user is acknowledged and operates the hand tool 10 slower until the pre-set torque is reached. When the pre-set torque is reached, the second light 23 lights up and the user is informed by the second light 23 and stops to rotate the hand tool 10. By this way, the workpiece is precisely applied with desired torque and the user receives two signals to ensure that the workpiece is properly tightened.

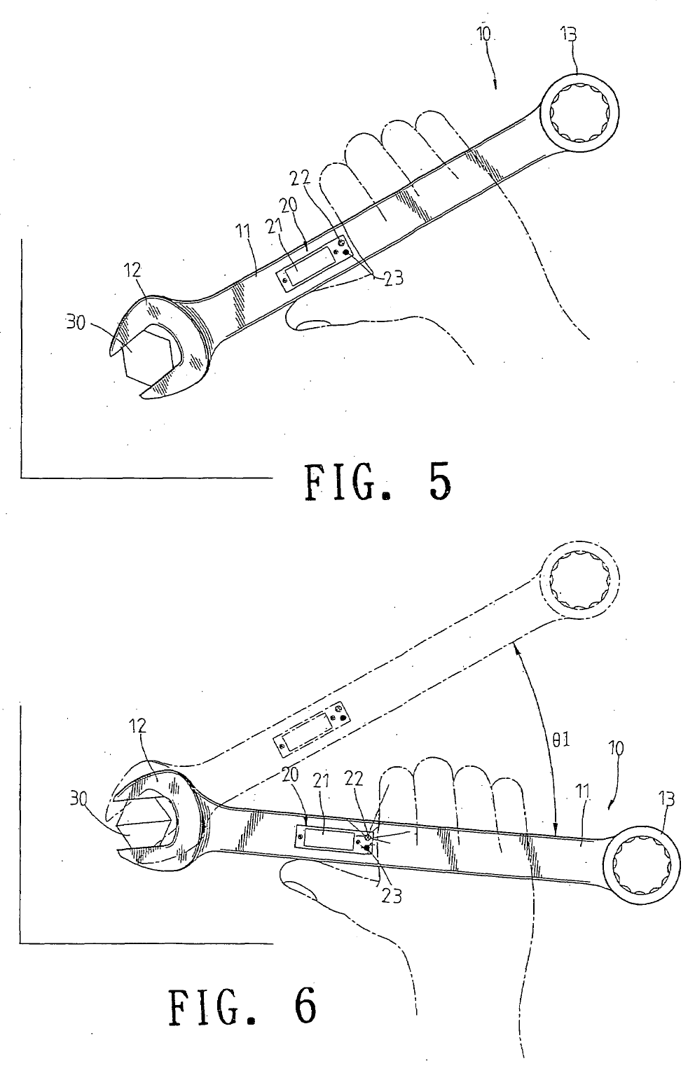

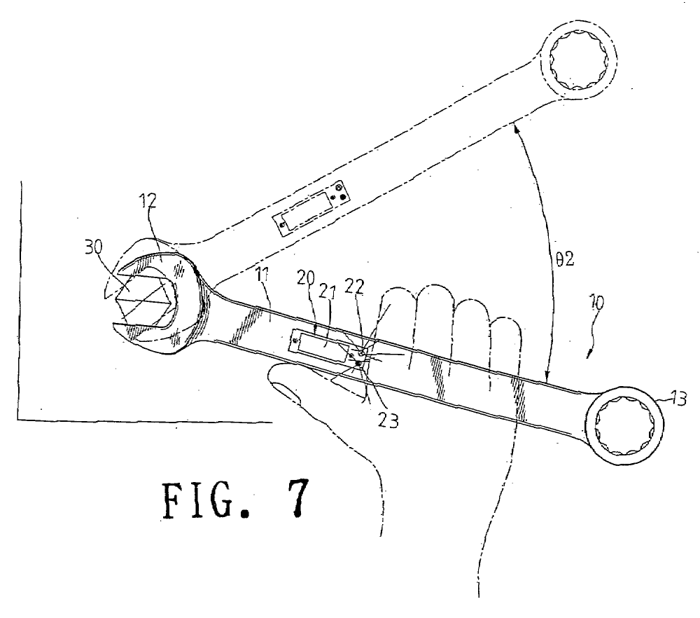

As shown in FIGS. 5 to 7, an alternative way of operation of the first and second lights 22, 23 is disclosed, wherein the first light 22 lights up when a pre-set torque is about to be reached, and the first and second lights 22, 23 both are flashing when the pre-set torque is reached. It is noted that, the number of the light can be only one which lights up when a pre-set torque is about to be reached, and flashes when the pre-set torque is reached.

While we have shown and described the embodiment in accordance with the present invention, it should be clear to those skilled in the art that further embodiments may be made without departing from the scope of the present invention.

What is claimed is:

1. A hand tool comprising:
a handle and a function end connected to one of two ends of the handle, a strain transducer connected to a side of the handle and electrically connected with a display member on the handle, the display member having a screen, a first light and a second light, the first light lighting up when a pre-set torque is about to be reached and the second light lighting up when the pre-set torque is reached.

2. The hand tool as claimed in claim 1, wherein the first light lights up when 90% of the pre-set torque is reached.

3. The hand tool as claimed in claim 1, wherein the first light is a green light and the second light is a red light.

4. A hand tool comprising:
a handle and a function end connected to one of two ends of the handle, a strain transducer connected to a side of the handle and electrically connected with a display member on the handle, the display member having a screen, a first light and a second light, the first light lighting up when a pre-set torque is about to be reached, the first and second lights both flashing when the pre-set torque is reached.

5. The hand tool as claimed in claim 4, wherein the first light lights up when 90% of the pre-set torque is reached.

6. The hand tool as claimed in claim 4, wherein the first light is a green light and the second light is a red light.
